(19) United States
(12) Patent Application Publication
(10) Pub. No.: US 2007/0171040 A1
(43) Pub. Date: Jul. 26, 2007

(54) Vehicle locator beacon

(76) Inventor: Shih-Hsiung Li, Taipei (TW)

Correspondence Address: HERSHKOVITZ & ASSOCIATES, 2845 DUKE STREET, ALEXANDRIA, VA, 22314, US

(21) Appl. No.: 11/337,537

(22) Filed: Jan. 24, 2006

(51) Int. Cl. B60Q 1/52

(52) U.S. Cl. 340/471

(57) ABSTRACT

A vehicle locator beacon includes a base defining a cavity, a control module mounted in the base and a light transmitter mounted on the base in a manner of able to adjust an angle. The control module includes a wireless receiver, a controller, and a human-body sensor. The control module is coupled to a light transmitter. By mounting the vehicle locator beacon at appropriate positions of the automobile, the driver can use the remote control lock to send out a driving signal to start the vehicle locator beacon.

### BACKGROUND OF THE INVENTION

1. Field of the Invention

The invention relates in general to vehicle locator beacon, and more particularly to an vehicle locator beacon that can be mounted on appropriate positions of an automobile to project an obvious light spot or pattern near a place where the automobile parks to facilitate the driver to find out the automobile.

2. Description of the Related Art

Automobiles are very common transportation nowadays. Due to the increasing numbers of automobiles everywhere, more and more underground parking areas and parking towers are constructed. In order to provide sufficient parking spaces, one layer of parking lot usually can afford numerous automobiles to park.

However, this situation causes inconvenience to drivers when they return to the parking lot to find out the automobiles. Especially when the light in the parking lot is dim or the drivers are not familiar to the environment of the parking lot, the drivers usually spend much time on looking for their automobiles.

In view of this inconvenient situation, a conventional method to solve this problem is that the drivers use remote control locks to start the automobiles, so that the automobiles can make beep sound to guide the drivers to find out their automobiles. However, a drawback of the conventional method is that the beep sound may have an echo around the parking lot, so as to cause noise and mislead the drivers to wrong locations of the automobiles.

### SUMMARY OF THE INVENTION

An objective of the present invention is to provide a vehicle locator beacon to facilitate drivers to find out their automobiles very quickly in a parking lot. A preferred embodiment of the vehicle locator beacon of the present invention includes a base forming a cavity, a control module and a light transmitter. The control module is mounted inside the base. The light transmitter is mounted on the base in a manner of able to adjust an angle.

The control module includes a wireless receiver, a controller, and a human-body sensor. The control module is connected to a light transmitter, so as to drive the light transmitter to light up in a remote control manner. The light transmitter is a laser transmitter.

The present invention makes good use of the remote control manner to drive the light transmitter to support the vehicle locator beacon. By mounting the vehicle locator beacon at different positions of the automobile, the driver can use the remote control lock to send out a driving signal to start the vehicle locator beacon when the driver returns to the parking lot to look for the automobile. The vehicle locator beacon then can cast a light-spot or a pattern on the wall above or near the automobile to guide the driver to find out the automobile very quickly. Hence the drawback of the inconvenience of looking for the automobile in the huge parking lot can be efficiently solved.

### BRIEF DESCRIPTION OF THE DRAWINGS

FIG. 1 is a cross sectional view in partial of an embodiment of a vehicle locator beacon in accordance with the present invention.

FIG. 2 is a circuit block diagram of the present invention.

FIG. 3 is an operational view showing an example of a position where the present invention can be mounted on an automobile.

FIG. 4 is a top view of several positions that the present invention can be mounted on an automobile.

FIG. 5 to FIG. 9 show the present invention can be mounted on the multiple positions of an automobile.

### DETAILED DESCRIPTION OF THE INVENTION

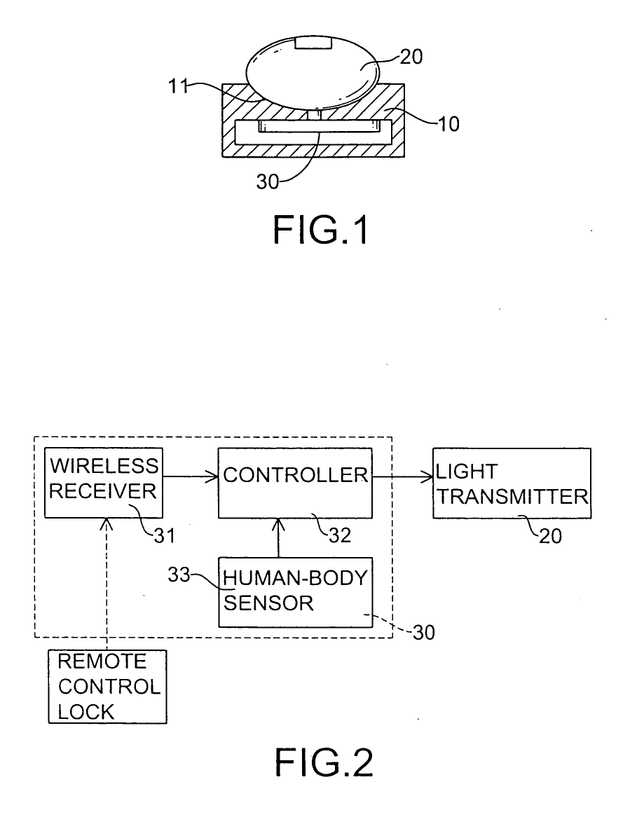

With reference to FIG. 1, a vehicle locator beacon of the present invention includes a base 10 defining a cavity 11, a control module 30 and a light transmitter 20. The control module 30 is mounted inside the base 10. The light transmitter 20 is movably mounted on the base 10 in a manner of able to adjust an angle. The light transmitter 20 can be pantoscopic to adjust an angle of an incident light.

With reference to FIG. 2, a control module 30 includes a wireless receiver 31, a controller 32 and a human-body sensor 33. The control module 30 is coupled to a light transmitter 20 to drive the light transmitter 20 to light up in a remote control manner. In this preferred embodiment, the light transmitter 20 is a laser transmitter.

The wireless receiver 31 is used for receiving a remote-controlled driving signal transmitted by a wireless manner. The remote-controlled driving signal is sent by a remote control lock or a remote controller of an automobile owner. The controller 32 includes an input terminal coupled to an output terminal of the wireless receiver 31 and an output terminal coupled to the light transmitter 20. The human-body sensor 33 is coupled to the controller 32 for sensing a location wherein the light transmitter 20 cast a light, so to detect whether there is any human or not. In order to avoid harm, if any animal or human is detected in the light-cast location, the human-body sensor 33 notifies the controller 32 to stop the light transmitter 20. Hence the light transmitter 20 does not cast the light. In terms of technique embodiment to implement the human-body sensor 33, the light transmitter is made up by an infrared sensor. Therefore the human-body sensor 33 can detect heat generated by the animal of the human to judge whether the animal or the human stays at the light-cast location.

The practicable example of the preferred embodiment of the present invention of the vehicle locator beacon is clearly described as above. Furthermore, an operation method of the preferred embodiment of the present invention is introduced as follows.

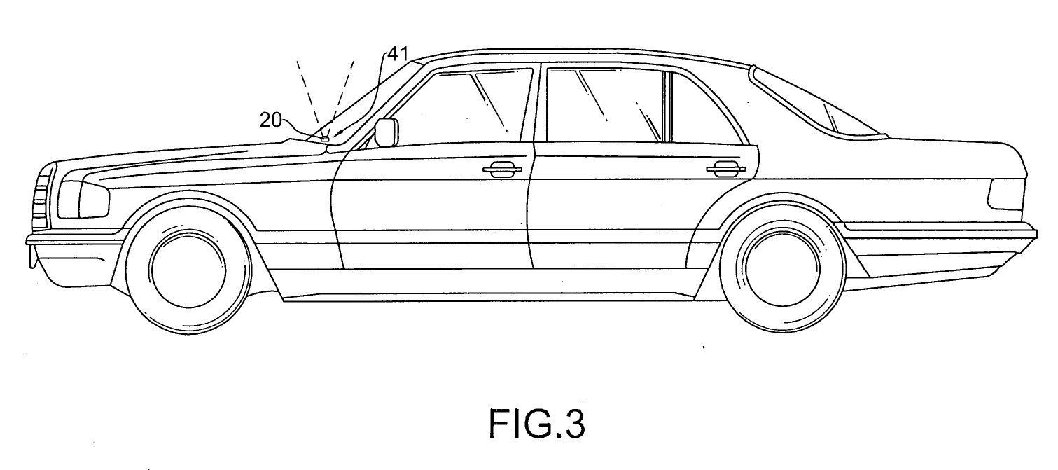

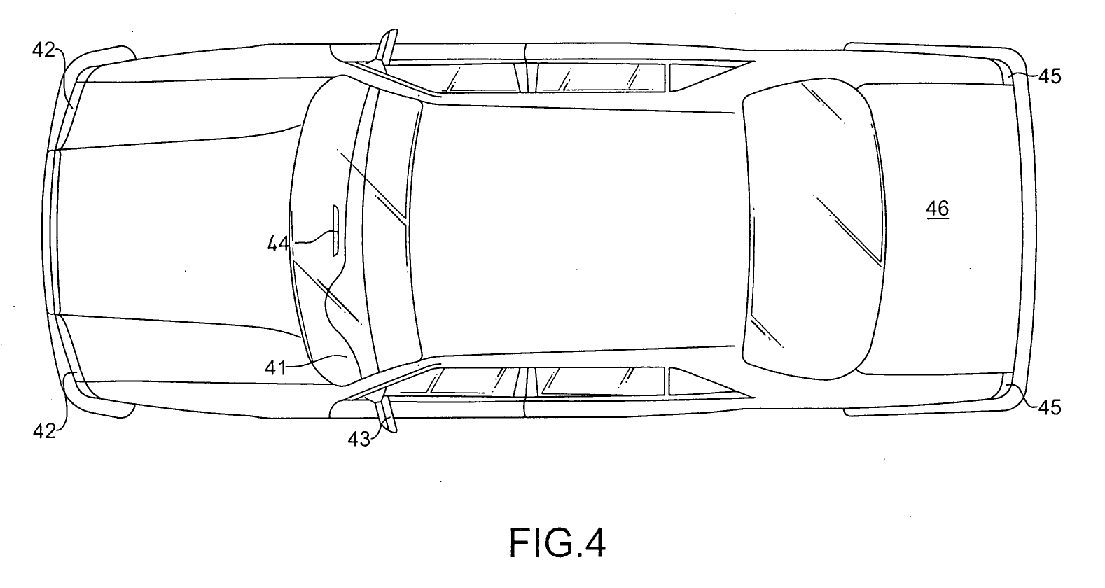

With reference to FIG. 3, the vehicle locator beacon can be mounted in an appropriate position in an automobile. A main principle of mounting for the vehicle locator beacon is to choose the appropriate position for the vehicle locator beacon to cast the light toward an external place of the automobile. In this usage illustration in the diagram, the vehicle locator beacon is fixed at a position 41 above a dashboard in front of a driver's seat to make the light transmitter 20 on the base 10 cast the light above toward a ceiling of a parking lot. If the automobile is parked next to a wall, the light transmitter 20 also can cast the light toward a top of the wall. When the driver returns to the parking lot, the driver can use the remote control lock to send out the driving signal. At this moment, the wireless receiver 31 of the control module 30 receives the remote-controlled driving signal to decode and then send to the controller 32. The controller 32 then drives the light transmitter 20 to generate the light and cast to a location to show a light-spot, so as to guide the driver the find the automobile very quickly. Moreover, the light transmitter 20 also can be mounted with a filter for extending a cast light-spot as a pattern, so as to form a more obvious target to let the drive find the automobile easily.

With reference to FIG. 4, several positions suitable for mounting the vehicle locator beacon are shown. For example, two positions 42 at both headlights of the automobile, a position 41 above a dashboard inside a front windscreen, two positions 43 at both rear-view mirrors of two front seats, a position 44 at a back mirror above the driver, two positions 45 at both taillights of the automobile, and two positions 46 at a top or a bottom of a rear windscreen.

Further, the position 41 above the dashboard inside the front windscreen as described in FIG. 3 also indicates a usage manner of the vehicle locator beacon. The light transmitter 20 casts the lights above, and the light goes through the front windscreen and forms the spot-light or the pattern on the ceiling above the automobile, so that facilitate the driver to find the automobile.

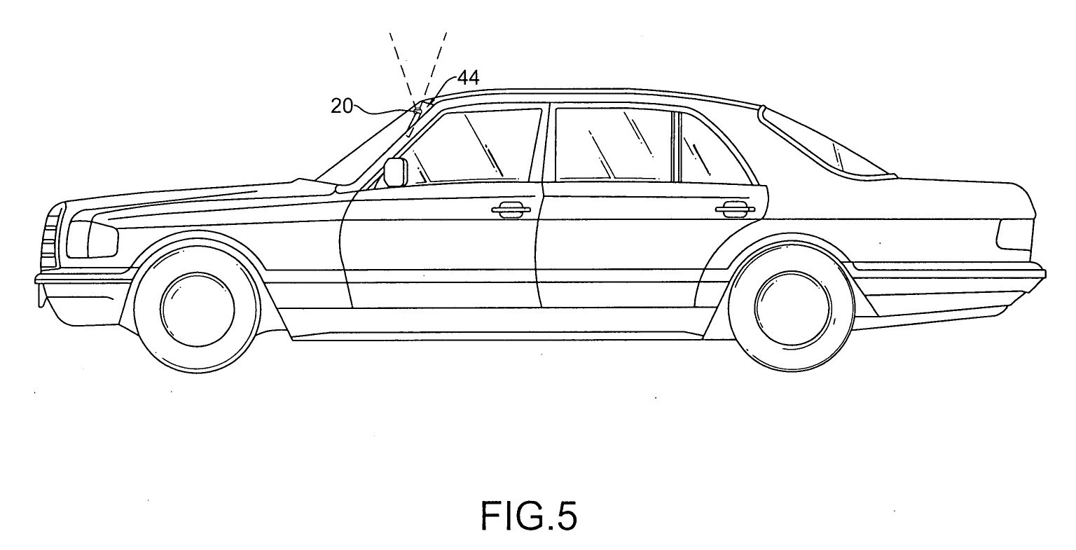

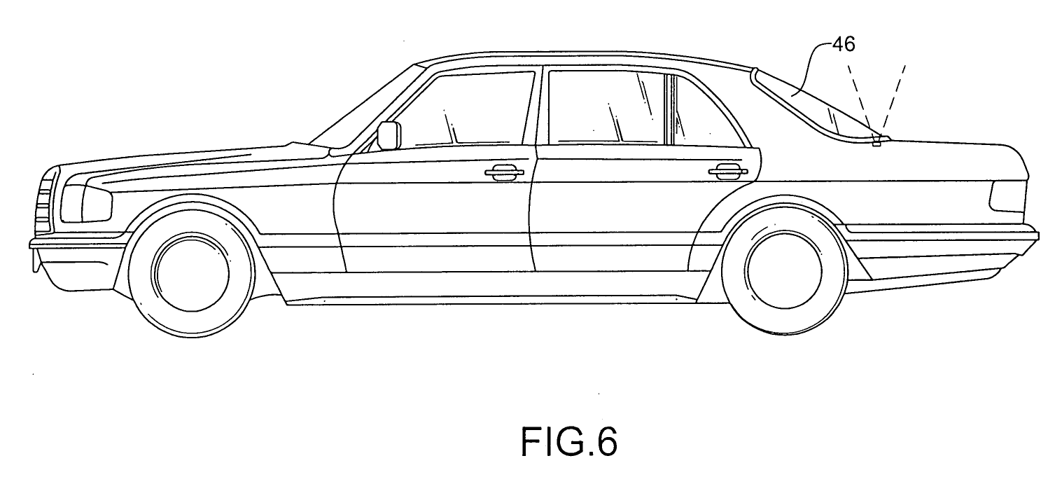

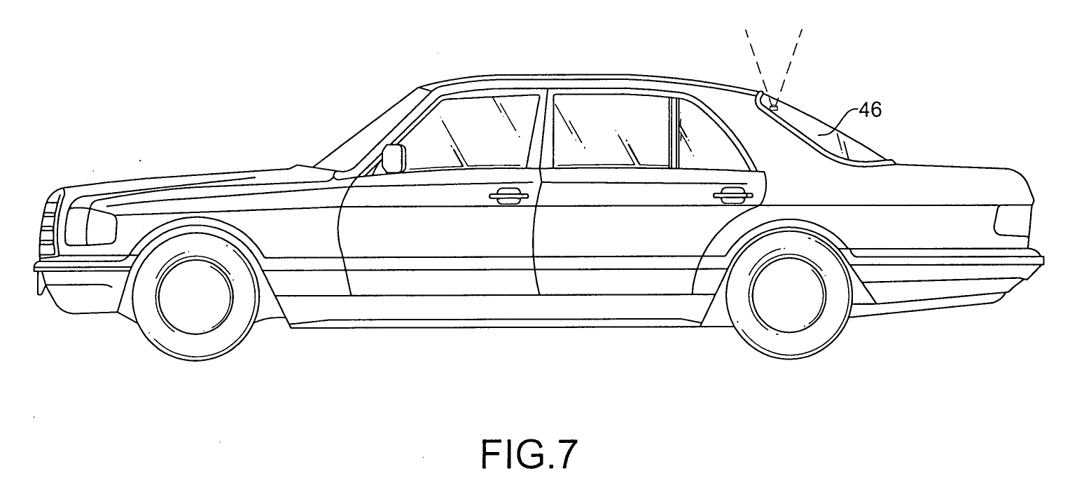

With reference to FIG. 5, a usage status of the vehicle locator beacon of the present invention mounted at the position 44 of the back mirror inside the automobile is indicated. Besides, FIG. 6 and FIG. 7 indicate the usage status of the vehicle locator beacon mounted at the positions 46 of the bottom or the top of the rear windscreen inside the automobile. A common characteristic of the aforesaid mounting positions is that all positions are located inside the automobile to make the light cast through the front windscreen or the rear windscreen to the corresponding positions when in use.

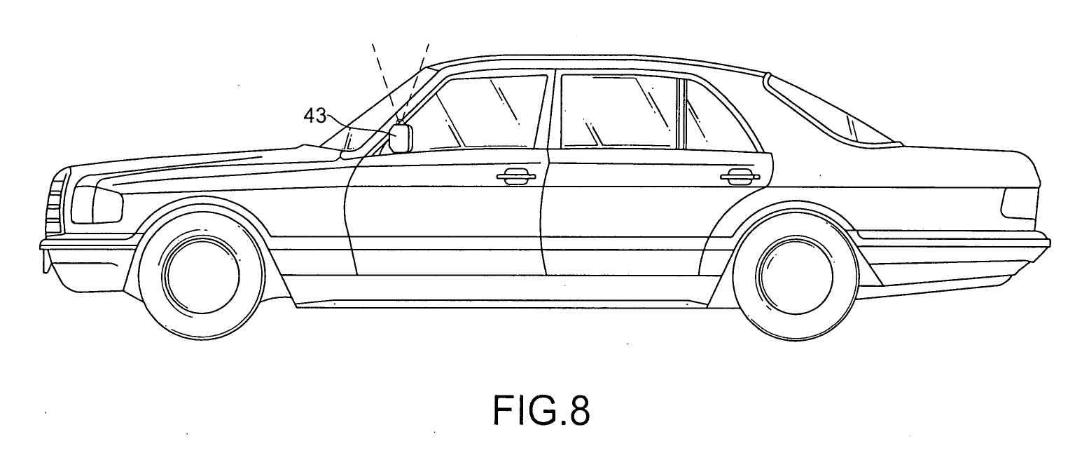

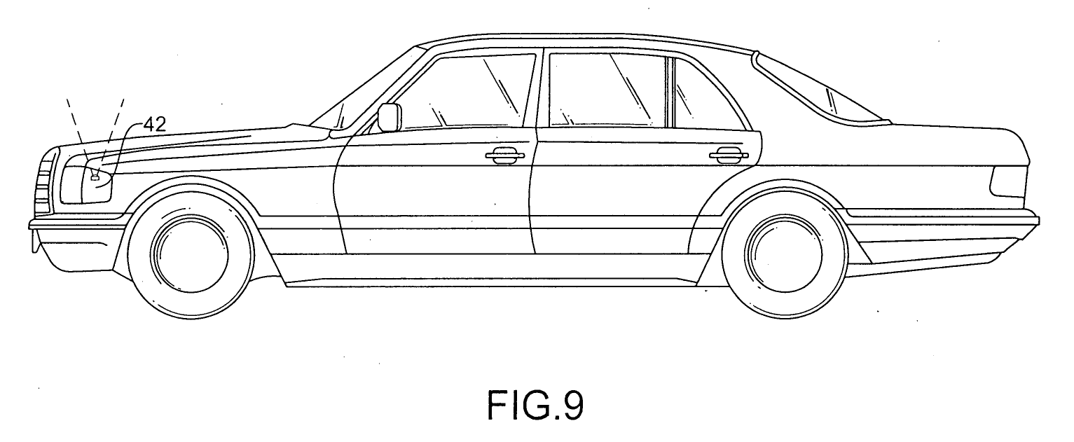

Furthermore, with reference to FIG. 8 and FIG. 9, the usage status of the vehicle locator beacon mounted at the positions 43 at the rear-view mirrors and the positions 42 at the headlights of the automobile is shown. A difference between these two diagrams and the diagrams of the FIG. 3, FIG. 5, FIG. 6 and FIG. 7 is that the vehicle locator beacon in these two diagrams is mounted at the positions outside the automobile, so that the light can be directly cast above or toward other appropriate angles without going through the windscreen.

Therefore, it can be clearly understood that the present invention makes good use of the remote control manner to drive the light transmitter to support the vehicle locator beacon. By mounting the vehicle locator beacon at the appropriate positions of the automobile, the driver can use the remote control lock to send out the driving signal to start the vehicle locator beacon when the driver returns to the parking lot to look for the automobile. The vehicle locator beacon then can cast the light-spot or the pattern on the wall above or near the automobile to guide the driver to find out the automobile very quickly. Hence the drawback of the inconvenience of looking for the automobile in the huge parking lot can be efficiently solved. Further, the light transmitter can adjust the angle of the cast light, so as to be able to determine the cast light direction to suit to local circumstances. Moreover, the vehicle locator beacon can further include the human-body sensor to ensure that the cast light will not cause any harm to the human or any animals. Therefore, the vehicle locator beacon of the present invention indeed includes features of good utility and unobviousness, so as to meet the requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A vehicle locator beacon comprising a base, a control module mounted inside the base and a light transmitter mounted on the base in a manner of able to adjust an angle, wherein the control module comprises:
a wireless receiver for receiving a remote-controlled driving signal transmitted by a wireless manner;
a controller comprising an input terminal connected to an output terminal of the wireless receiver and having an output terminal connected to the light transmitter.

2. The vehicle locator beacon as claimed in claim 1, wherein the control module further comprises a human-body sensor connected to the controller.

3. The vehicle locator beacon as claimed in claim 2, wherein the human-body sensor is an infrared sensor.

4. The vehicle locator beacon as claimed in claim 1, wherein the base defines a cavity and the light transmitter is mounted in the cavity.

5. The vehicle locator beacon as claimed in claim 1, wherein the light transmitter is a laser transmitter.

6. The vehicle locator beacon as claimed in claim 2, wherein the light transmitter is a laser transmitter.

7. The vehicle locator beacon as claimed in claim 3, wherein the light transmitter is a laser transmitter.

8. The vehicle locator beacon as claimed in claim 4, wherein the light transmitter is a laser transmitter.

9. The vehicle locator beacon as claimed in claim 5, wherein the light transmitter further comprises a filter to spread a light-spot as a pattern.

10. The vehicle locator beacon as claimed in claim 6, wherein the light transmitter further comprises a filter to spread a light-spot as a pattern.

11. The vehicle locator beacon as claimed in claim 7, wherein the light transmitter further comprises a filter to spread a light-spot as a pattern.

12. The vehicle locator beacon as claimed in claim 8, wherein the light transmitter further comprises a filter to spread a light-spot as a pattern.

13. A method for looking for an target vehicle, the method comprising acts of:
mounting an vehicle locator beacon on a vehicle, wherein the vehicle locator beacon comprises a base, a control module mounted inside the base and a light transmitter mounted on the base;
emitting an wireless signal from a remote control to activate the light transmitter to send a light on a place near the vehicle; and
observing the light to find the vehicle.

14. The method as claimed in claim 13, wherein the light transmitter sends a light spot on the place near the vehicle.

15. The method as claimed in claim 13, wherein the light transmitter sends a pattern on the place near the vehicle.

16. The method as claimed in claim 14, wherein the light spot is projected on a ground surface.

17. The method as claimed in claim 15, wherein the pattern is projected on a ground surface.

18. The method as claimed in claim 14, wherein the light spot is projected on a ceiling above the vehicle.

19. The method as claimed in claim 15, wherein the pattern is projected on a ceiling above the vehicle.
